(19) United States
(12) Patent Application Publication
(10) Pub. No.: US 2025/0236122 A1
(43) Pub. Date: Jul. 24, 2025

(54) ROLLED PAPER HOLDER AND PRINTER

(71) Applicant: TOSHIBA TEC KABUSHIKI KAISHA, Tokyo (JP)

(72) Inventor: Yuji KAWAMORITA, Mishima Shizuoka (JP)

(73) Assignee: TOSHIBA TEC KABUSHIKI KAISHA, Tokyo (JP)

(21) Appl. No.: 18/974,231

(22) Filed: Dec. 9, 2024

(30) Foreign Application Priority Data
Jan. 24, 2024 (JP) 2024-008888

(51) Int. Cl. B41J 15/04; B41J 11/04

(52) U.S. Cl. CPC B41J 15/042; B41J 11/04

(57) ABSTRACT

According to an embodiment, a rolled paper holder holding and positioning a roll of paper including a rolled sheet of paper in a width direction includes: a container section configured to contain the roll of paper in a space surrounded by a peripheral surface portion and a pair of side walls, a shaft extending between the pair of side walls, a press portion configured to press an end part of the roll of paper, a grip configured to grip the shaft pivotably along an outer circumferential surface of the shaft, and one or more positioning projections positioned on an end of the press portion. The positioning projections may be configured to (a) fit into one or more openings formed in the peripheral surface portion and (b) position the press portion in a width direction corresponding to a width of the sheet of paper.

### CROSS-REFERENCE TO RELATED APPLICATION

This application is based upon and claims the benefit of priority from Japanese Patent Application No. 2024-008888, filed on Jan. 24, 2024, the entire contents of which are incorporated herein by reference.

### TECHNICAL FIELD

Embodiments described herein relate generally to a rolled paper holder and a printer.

### BACKGROUND

For printers using rolls of paper with rolled belt-like sheets, a printer supporting a plurality of sheet widths includes a configuration such as a plate-like member (e.g., a pressing plate or the like) for positioning the roll of paper in a width direction. The pressing plate is attached to a position for pressing a side end part of the roll of paper and used.

The pressing plate can be attached to and detached from a predetermined position within a container section containing the roll of paper. For example, the pressing plate is detached from the container section when a roll of paper having a larger width dimension is used and attached to the container section when a roll of paper having a smaller width dimension is used.

However, according to the above-described configuration, the pressing plate is detached from the container section when not used and, for example, separated from the printer and put away. Accordingly, the pressing plate may be lost and an improvement for the loss is desired.

There are examples of printers including pressing plates not removed from inside container sections. However, it is not appropriate to provide those pressing plates in printers to which detachable pressing plates are applied because too much space is required, and structures become complex.

### BRIEF DESCRIPTION OF THE DRAWINGS

FIG. 1 is a perspective view showing an example of an appearance of a printer, according to an embodiment.

FIG. 2 is a sectional view showing an example of an internal structure of the printer of FIG. 1.

FIG. 3 is a side view of the printer of FIG. 1 with a lid unit open.

FIG. 4 is a side view of the printer of FIG. 1 with a sheet width guide moved up.

FIG. 5 is a side view of the sheet width guide of FIG. 4.

FIG. 6 is a perspective view of an attached state of the sheet width guide, according to an embodiment.

FIG. 7 is an enlarged perspective view showing a shaft portion and a grip portion partially in a sectional view, according to an embodiment.

FIG. 8 is a perspective view showing a grip portion, according to a modified embodiment.

### DETAILED DESCRIPTION

A challenge to be solved by the present disclosure is to provide a structure that can prevent a loss of a member corresponding to a plurality of sheet widths in a printer using a roll of paper.

In general, according to an embodiment, a rolled paper holder holding and positioning a roll of paper including a rolled sheet of paper in a width direction includes: a container section configured to contain the roll of paper in a space surrounded by a peripheral surface portion and a pair of side walls, a shaft extending between the pair of side walls, a press portion moveable in a direction to be against an end part of the roll of paper, and a grip configured to grip the shaft pivotably along an outer circumferential surface of the shaft. The grip is moveable together with the press portion. The rolled paper holder includes one or more positioning projections positioned on an outer portion of the press portion, the positioning projections being configured to (a) fit into one or more openings formed in the peripheral surface portion and (b) position the press portion in a width direction corresponding to a width of the sheet of the roll of paper.

### First Embodiment

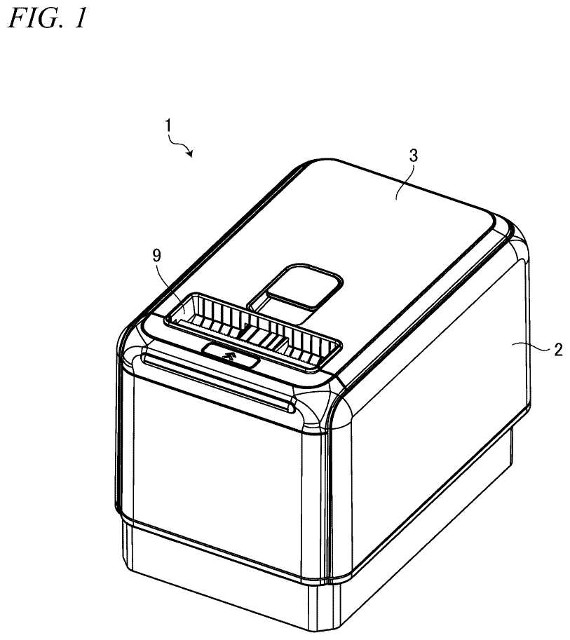

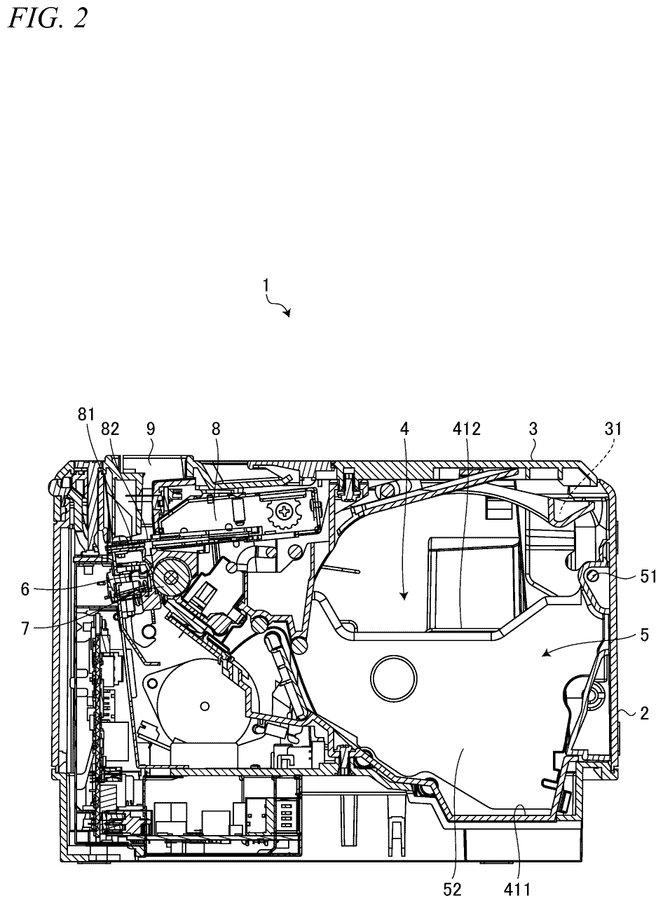

An embodiment will be explained using the drawings. FIG. 1 is a perspective view showing an example of an appearance of a printer 1 of the embodiment. FIG. 2 is a sectional view showing an example of an internal structure of the printer 1. The printer 1 includes a housing 2, a lid unit 3, a holder unit 4, a printing head 6, a platen roller 7, a cutter unit 8, etc.

Here, in the perspective view of FIG. 1, a front surface and a right side surface of the printer 1 are shown and a left side surface and a back surface of the printer 1 are not shown. The printer 1 is mainly used in a position with the lid unit 3 facing upward as shown in FIG. 1 or a position with the surface on the near side in FIG. 1 facing upward.

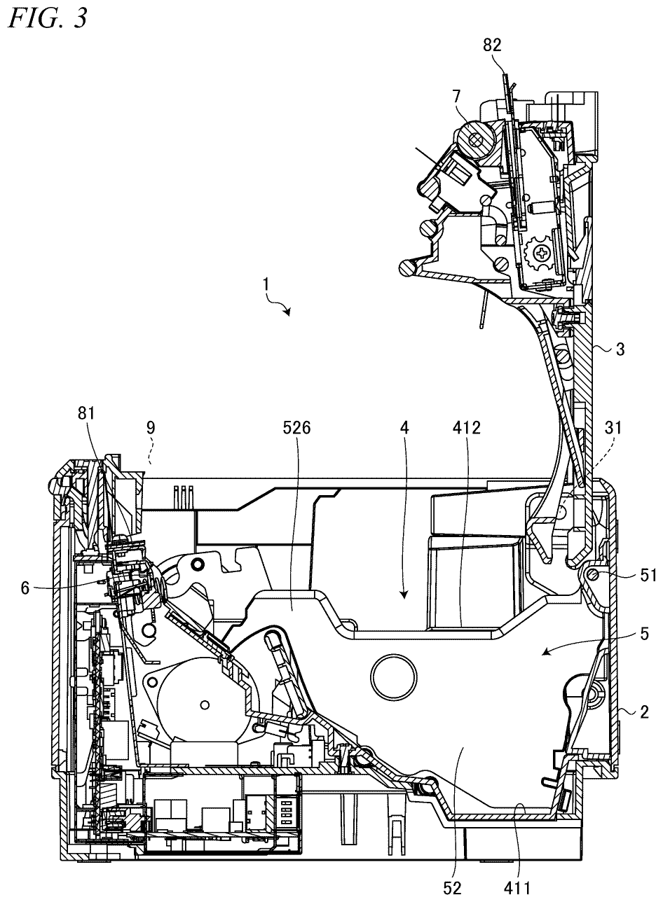

FIG. 3 shows the printer 1 with the lid unit 3 open, according to an embodiment. The housing 2 is a container having an open portion (e.g., a cavity) that may be opened and closed by the lid unit 3. The lid unit 3 is attached (e.g., coupled to, affixed to, etc.) to a first end of the open portion of the housing 2 and pivotably around a shaft 31 positioned on the first end. The lid 3 moves between a position in which the open portion of the housing 2 is closed (i.e., a closed position) and a position in which the open portion is opened (i.e., an open position) by pivoting the lid unit 3 around the shaft 31. When the lid unit 3 is in the closed position, a paper ejection opening 9 is formed between a second end (e.g., an end opposite to the first end) of the lid unit 3 and the housing 2.

The holder unit 4 is an example of a rolled paper holder which holds and positions a roll of paper in a width direction thereof (e.g., a lateral direction, etc.). The roll of paper is a roll of a belt-like sheet of paper. The sheet includes common paper such as receipt paper, labels having predetermined dimensions adhered to a belt-like backing paper, and a belt-like label without a liner.

The printing head 6 is for printing on a sheet nipped (e.g., positioned) between the platen roller 7 and itself (e.g., a line thermal head in which many heating elements are arranged along a sheet width direction). The platen roller 7 is a roller having elasticity in a surface thereof and is rotationally driven to convey the sheet nipped between the printing head 6 and itself.

The printing head 6 is provided within the housing 2, the platen roller 7 is attached to the lid unit 3, and the printing head 6 and the platen roller 7 move closer to and away from each other with the pivotal movement of the lid unit 3 (e.g., between the open position and the closed position). Further, when the printing head 6 and the platen roller 7 move away from each other, a sheet conveyance path is opened.

The cutter unit 8 is attached to the lid unit 3 and is located downstream of the printing head 6 and the platen roller 7 in a sheet conveyance direction. The cutter unit 8 cuts the printed sheet.

The cutter unit 8 has/includes a blade, shown as a fixed blade 81 and a movable blade 82. The fixed blade 81 and the movable blade 82 are placed with cutting edges opposed to each other and the sheet conveyance path is positioned in between the cutting edges in a sheet thickness direction. The fixed blade 81 is fixed within the housing 2. The movable blade 82 is attached to the lid unit 3 and moves in directions closer to or away from the fixed blade 81 when subjected to a drive force. The cutting edge of the movable blade 82 slides with the cutting edge of the fixed blade 81, and thereby, the sheet nipped therebetween is cut.

### Details of Holder Unit 4

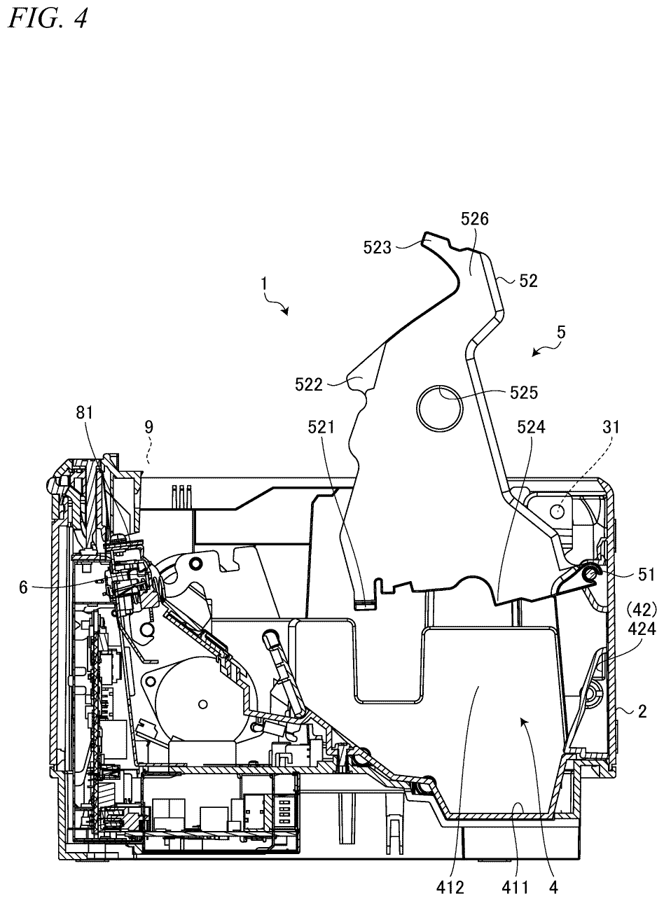

Here, the holder unit 4 includes a container section 41 and a sheet width guide 5. FIG. 4 shows the printer 1 with the sheet width guide 5 moved up.

The container section 41 contains a roll of paper in a space surrounded by a peripheral surface portion 411 and a pair of side walls 412. The space is provided within the housing 2 and opened and closed by the lid unit 3. A cylindrical outer circumferential surface of the roll of paper contacts the peripheral surface portion 411. The side walls 412 form a pair of surfaces opposed with the peripheral surface portion 411 in between.

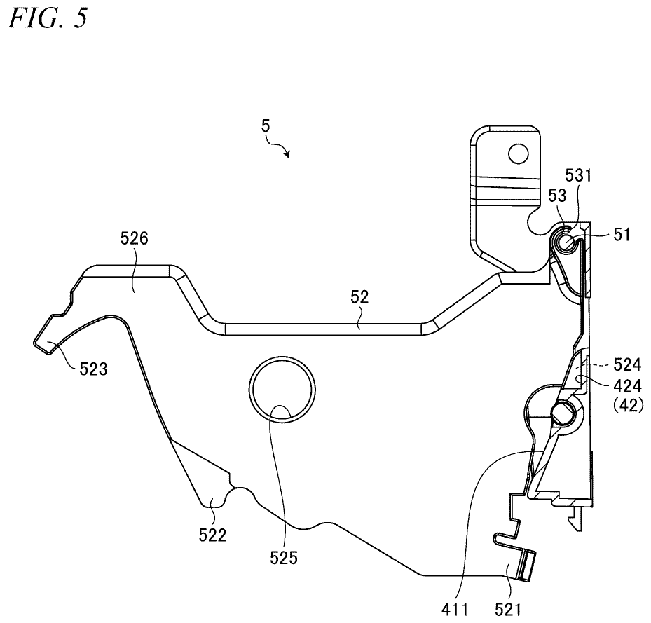

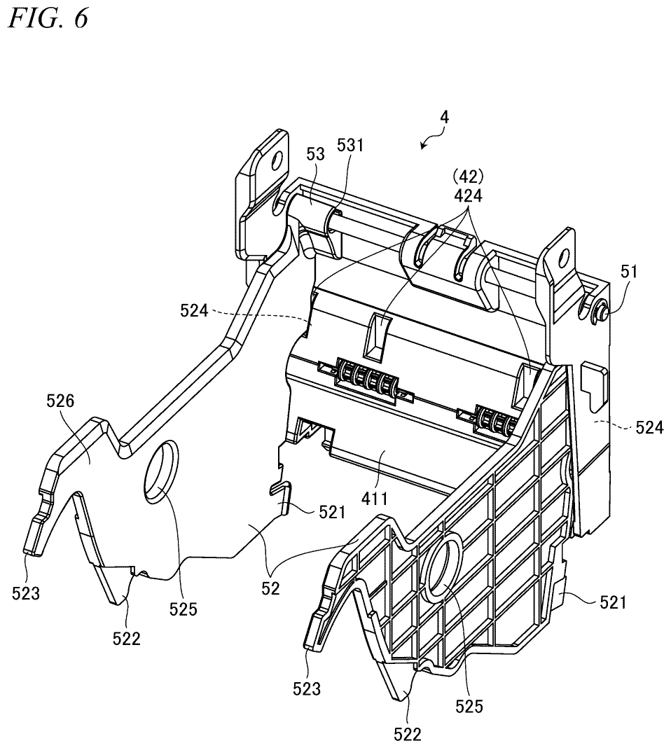

FIG. 5 is a side view of the sheet width guide 5. FIG. 6 is a perspective view showing an example of an attached state of the sheet width guide 5. The sheet width guide 5 includes a shaft, shown as shaft portion 51, a pressing portion 52 (e.g., a press, a press portion, etc.), a grip, shown as grip portion 53, and positioning portions (e.g., projections, positioning projections, etc.).

In a center part of the pressing portion 52, a hole 525 is formed for an operator to easily perform operation of attaching and detaching the pressing portion 52 with a finger inserted therein for changing the position of the pressing portion 52 (e.g., the pressing portion 52 is movable). Further, the pressing portion 52 includes a sub-pressing portion 526 (e.g., sub-press, a sub-press portion, etc.) located between a sheet printing position and the container section 41. The sub-pressing portion 526 presses a side end part of the sheet pulled out from the roll of paper and restricts the position of the sheet in the width direction anterior to the printing head 6 and the platen roller 7.

The positioning portions include one or more concavo-convex shapes 521, 522, 523, 524 provided in edge parts of the pressing portion 52. The positioning portions (e.g., concavo-convex shapes 521 to 524) fit into (e.g., removably coupled with) concavo-convex shapes 42 formed in the peripheral surface portion 411 (e.g., holes 424 shown in FIGS. 4 and 6 or the like) to position the pressing portion 52 in the sheet width direction, thereby restricting movement in the sheet width direction. The concavo-convex shapes 42 are provided in positions according to types of sheet widths used for the printer 1. For example, if the holder unit 4 holds a roll of paper having the largest width used for the printer 10, then the pressing portion 52 is positioned in contact with the side wall 412.

A plurality of the holes 424 are arranged along a width direction of the peripheral surface portion 411 of the holder unit 4. The concavo-convex shapes 524 of the positioning portion are inserted into one or more of the holes 424. Similarly, a plurality of other concavo-convex shapes 42 and holes 424 are arranged along the width direction of the peripheral surface portion 411, and the respective concavo-convex shapes 521 to 523 as the corresponding positioning portions are inserted into ones of the shapes (e.g., the other concavo-convex shapes 42, the holes 424, etc.).

The sheet width guide 5 includes at least four positioning portions (e.g., concavo-convex shapes 521 to 524), according to an embodiment. The concavo-convex shapes 521 to 524 are projections inserted into the holes 424 to form the concavo-convex shapes 42 in the peripheral surface portion 411. The concavo-convex shape 524 is inserted into the hole 424. Further, the concavo-convex shape 521 has a hook shape at an end. When the concavo-convex shape 521 is inserted into the hole 424 as one of the concavo-convex shapes 42, the hook shape at the end of the concavo-convex shape 521 is caught on the edge of the hole 424.

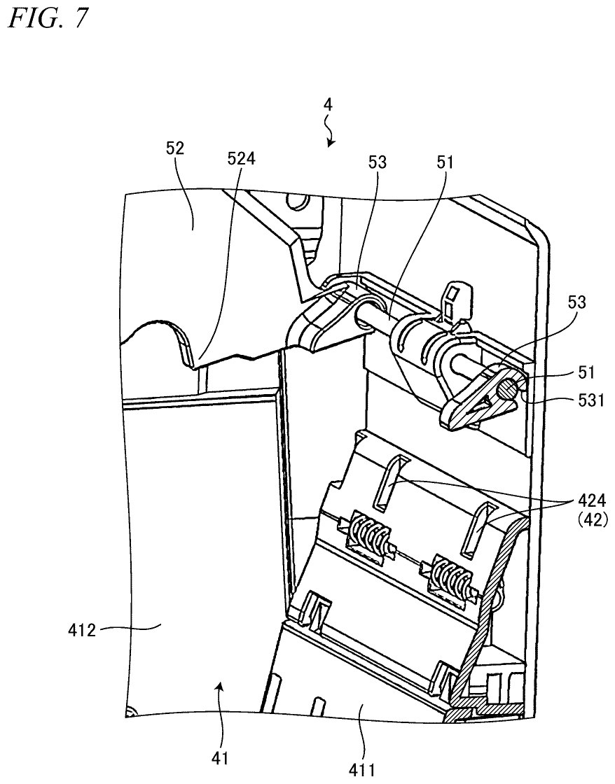

FIG. 7 is an enlarged perspective view showing the shaft portion 51 and the grip portion 53 (e.g., the grip) partially in a sectional view. The shaft portion 51 is a cylindrical member bridged between (e.g., extending between, positioned between, forming a bridge between, etc.) the pair of side walls 412. The shaft portion 51 is placed (e.g., positioned, located, etc.) at an opposite side and in a direction in which the sheet pulled out from the roll of paper is conveyed. That is, the shaft portion 51 is located at an opposite side to the sheet printing position (e.g., the position where the printing head 6 and the platen roller 7 are located) with the roll of paper contained in the container section 41 in between.

The pressing portion 52 is a plate-like member pressing the side end part of the roll of paper. The grip portion 53 and the positioning portions (concavo-convex shapes 521 to 524) are provided in the edge parts of the pressing portion 52 and are continuous with the pressing portion 52.

The grip portion 53 grips the shaft portion 51 pivotably along the outer circumferential surface of the shaft portion 51 and movably in the longitudinal direction (e.g., along the length of the shaft). Further, the grip portion 53 has a tubular shape in which an opening, shown as cutout 531, is formed. The cutout 531 (e.g., the opening) is formed by partial cutting of a tube along an axial direction of the tube and interrupts the circumferential continuity of the tubular-shaped grip portion 53. The width of the cutout 531 is normally smaller than the thickness of the shaft portion 51.

The grip portion 53 and the pressing portion 52 and the positioning portions continuous therewith are formed using a resin, according to an embodiment. The grip portion 53 has an elasticity that can allow changes in the width of the cutout 531 (e.g., because the portion of the grip portion 53 having the cutout 531 is formed using the resin). The degree of the elasticity of the grip portion 53 is a degree at which, when a force in a twisting direction with respect to the shaft portion 51 is applied to the grip portion 53, the cutout 531 can be sufficiently opened to substantially the same size as the thickness of the shaft portion 51. Thereby, when the pressing portion 52 is moved along the shaft portion 51, if a force in the twisting direction with respect to the shaft portion 51 is applied to the grip portion 53, the shaft portion 51 passes through the open cutout 531 and is detached from the grip portion 53. Therefore, inconvenient breaking of the grip portion 53 due to excessive force may be avoided or mitigated.

Note that “with the sheet width guide 5 moved up” in the above-described explanation of FIG. 4 refers to a state in which the pressing portion 52 is detached from inside the container section 41, more specifically, a state in which the grip portion 53 is pivoted relative to the shaft portion 51 and the pressing portion 52 is separated from the peripheral surface portion 411. The positioning portions (concavo-convex shapes 521 to 524) are attached to and detached from the concavo-convex shapes 42 of the peripheral surface portion 411 with the pivot of the pressing portion 52 around the shaft portion 51.

In the printer 1 having the above-described configuration, the sheet width guide 5 restricts the movement of the roll of paper contained in the container section 41 in the width direction.

The pressing portion 52 presses the side end parts of the roll of paper and the sheet pulled out from the roll of paper, thereby positioning the sheet in the width direction. When the width of the roll of paper used for the printer 1 is changed, an operation for changing the position of the pressing portion 52 to a position according to the width dimension of the roll of paper is performed. The operation for the change is performed in the following manner.

An operator applies a force in a direction away from the container section 41 to the pressing portion 52 with a finger or the like inserted in the hole 525. Thereby, the pressing portion 52 pivots around the shaft portion 51 and the concavo-convex shapes 521 to 524 as the positioning portions move out of the concavo-convex shapes 42. In this state, the restriction of the movement in the sheet width direction of the pressing portion 52 is released and the pressing portion 52 becomes movable in the sheet width direction.

Then, the operator moves the pressing portion 52 in the sheet width direction. Concurrently, the grip portion 53 moves along the shaft portion 51 (e.g., the grip portion 53 is moveable together with the pressing portion 52). Here, when a twisting force not along the shaft portion 51 is applied to the grip portion 53, the force elastically deforms the grip portion 53 and opens the cutout 531. When the cutout 531 is opened to be larger than the thickness of the shaft portion 51, the shaft portion 51 is moved out of the cutout 531 and the shaft portion 51 is released from grip by the grip portion 53. That is, the pressing portion 52 is detached. Thereby, unintended breakage of the grip portion 53 when the pressing portion 52 moves is avoided.

Then, the operator applies a force in a direction for insertion into the container section 41 to the pressing portion 52 reaching a desired position along the shaft portion 51. The pressing portion 52 pivots around the shaft portion 51 and is inserted into the container section 41. When the pressing portion 52 is inserted into the container section 41, the concavo-convex shapes 521 to 524 as the positioning portions are fitted in the corresponding concavo-convex shapes 42. Thereby, the pressing portion 52 is positioned (e.g., in the sheet width direction).

Then, the operator puts a roll of paper having a desired width into the container section 41, pulls out paper from the roll of paper to the position between the printing head 6 and the platen roller 7, and closes the lid unit 3. Here, preparation of the roll of paper in the printer 1 is completed.

As described above, according to an embodiment, the pressing portion 52 is movable in the sheet width direction within the container section 41. Thereby, it is no longer necessary to detach the pressing portion 52 from inside the container section 41. Accordingly, a loss of the pressing portion 52 may be prevented. Further, due to the structure of the location where the pressing portion 52 and the grip portion 53 are connected, breakage of the grip portion 53 is concerned when the pressing portion 52 is moved. However, the cutout 531 is formed in the grip portion 53 and the grip portion 53 is detached from the shaft portion 51 before being broken. Therefore, the breakage of the grip portion 53 may be avoided or mitigated.

As described above, according to an embodiment, a structure that can prevent a loss of a member for supporting a plurality of sheet widths in a printer using a roll of paper may be provided.

### Modified Example

The above-described embodiment can be appropriately modified and implemented by alterations of part of configurations or functions of the above-described respective devices.

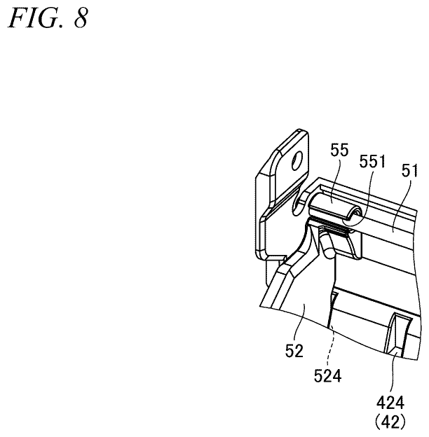

For example, FIG. 8 is a perspective view showing a grip portion 55 in a modified example. As shown in FIG. 8, the pressing portion 55 of the modified example includes a cutout 551.

The cutout 531 formed in the grip portion 53 of the embodiment opens toward a deeper side than the shaft portion 51 as seen from the pressing portion 52 side, however, the cutout 551 of the modified example opens toward the pressing portion 52 side. The cutout 531 and the cutout 551 are provided in parts to which forces are applied when the grip portions 53, 55 are pulled or pushed via the pressing portion 52 with the pressing portion 52 moved up from the container section 41 as shown in FIG. 4. Thereby, breakage of the grip portions 53, 55 may be effectively prevented.

While certain embodiments have been described, these embodiments have been presented by way of example only and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A rolled paper holder for holding and positioning a roll of paper including a rolled sheet of paper in a width direction, the rolled paper holder comprising:
a container section configured to contain the roll of paper in a space surrounded by a peripheral surface portion and a pair of side walls;
a shaft extending between the pair of side walls;
a press portion moveable in a direction to be against an end part of the roll of paper;
a grip configured to grip the shaft pivotably along an outer circumferential surface of the shaft, the grip being moveable together with the press portion; and
one or more positioning projections positioned on an outer portion of the press portion, the positioning projections being configured to (a) fit into one or more openings formed in the peripheral surface portion and (b) position the press portion in a width direction corresponding to a width of the sheet of the roll of paper.

2. The rolled paper holder of claim 1, wherein the grip is movable in along a length of the shaft.

3. The rolled paper holder of claim 1, wherein the grip includes a tubular portion that surrounds the shaft, the tubular portion including an opening that interrupts continuity in a circumferential direction of the tubular portion.

4. The rolled paper holder of claim 3, wherein the grip has an elasticity that allows the width of the opening to change when a twisting force is applied to the grip.

5. The rolled paper holder of claim 4, wherein the width of the opening is configured to change to allow the shaft to pass through the opening, thereby detaching the shaft from the grip.

6. The rolled paper holder of claim 1, wherein the one or more openings formed in the peripheral surface portion are concavo-convex in shape.

7. The rolled paper holder of claim 1, wherein the one or more openings formed in the peripheral surface portion are holes extending through the peripheral surface portion.

8. The rolled paper holder of claim 1, wherein the press portion includes a sub-press portion located between a printing position of the sheet and the container section, the press portion configured to press an end part of the sheet pulled out from the roll of paper.

9. The rolled paper holder of claim 8, wherein the shaft is positioned on a side opposite to an end of the roll of paper from which the sheet is pulled.

10. The rolled paper holder of claim 1, wherein the positioning projections are attached to and detached from the openings formed in the peripheral surface portion by pivoting the press portion around the shaft.

11. A printer comprising:
the rolled paper holder according to claim 1:
a printing head configured to print on the sheet pulled from the roll of paper positioned within the rolled paper holder; and
a platen roller configured to convey the sheet positioned between the printing head and the platen roller.

12. The printer of claim 11, wherein the press portion includes a sub-press portion restricts the position of the sheet in the width direction anterior to the printing head and the platen roller.

13. The printer of claim 11, wherein the shaft is positioned on an opposite side of the roll of paper relative to the printing head and the platen roller.

14. The printer of claim 11, wherein the positioning projections of the rolled paper holder are configured to be attached to the openings formed in the peripheral surface portion according to the width of the roll of paper.

15. The printer of claim 14, wherein the grip is configured to move in along a length of the shaft of the rolled paper holder such that a position of the grip corresponds with the position of the positioning projections and the width of the roll of paper.
